(19) United States
(12) Patent Application Publication
(10) Pub. No.: US 2025/0193518 A1
(43) Pub. Date: Jun. 12, 2025

(54) RANGING DEVICE, METHOD OF CONTROLLING RANGING DEVICE, AND STORAGE MEDIUM

(71) Applicant: CANON KABUSHIKI KAISHA, Tokyo (JP)

(72) Inventor: AYUMU NEMOTO, Tokyo (JP)

(21) Appl. No.: 18/969,617

(22) Filed: Dec. 5, 2024

(30) Foreign Application Priority Data
Dec. 11, 2023 (JP) 2023-208686

(51) Int. Cl. H04N 23/67; G01S 17/10; G01S 17/894; H04N 23/62; H04N 23/667; H04N 23/80

(52) U.S. Cl. CPC H04N 23/671; H04N 23/62; H04N 23/667; H04N 23/80; G01S 17/10; G01S 17/894

(57) ABSTRACT

A ranging device that is communicably connected to an image capturing unit that captures an image of an object, a focus adjustment unit that performs focus adjustment with respect to the object for the image capturing unit, and a recording unit that is capable of executing record processing for recording image data of the object subjected to image capturing by the image capturing unit. A ranging section measures a distance to the object. A system controller determines whether or not the object is in an in-focus state, based on a result of the focus adjustment, and in a case where, even when the distance has been measured by the ranging unit, it is determined that the object is not in the in-focus state, the system controller can perform control to restrict execution of the record processing.

### BACKGROUND OF THE INVENTION

### Field of the Invention

The present invention relates to a ranging device that makes it possible to record image data in a preferable state, a method of controlling the ranging device, and a storage medium.

### Description of the Related Art

There is known a ranging device that measures a distance to an object to be measured by using the Time Of Flight (TOF) method (see e.g. Japanese Laid-Open Patent Publication (Kokai) No. 2014-115191). A ranging device described in Japanese Laid-Open Patent Publication (Kokai) No. 2014-115191 includes a light emission section that emits invisible light toward an object to be measured, a light receiving section that receives the invisible light reflected from the object to be measured, converts the received light to electrical signals, and outputs the electrical signals, and a distance calculation section that calculates a distance to the object to be measured based on the electrical signals received from the light receiving section. Further, there is also known a ranging device that has not only the function of measuring a distance to an object by using the TOF method, but also a function of adjusting focus with respect to an object and an image capturing function of capturing an image of an object (see e.g. Japanese Laid-Open Patent Publication (Kokai) No. 2002-207163).

The ranging operation using the TOF method has a fear that reflected light having intensity necessary for ranging cannot be obtained depending on the shape of an object to be measured, a distance to the object to be measured, or the like, which makes it difficult to accurately perform ranging. Further, there is a fear that it is impossible to perform focus adjustment suitable for image capturing, i.e. it is impossible to focus on the object to be measured depending on brightness/darkness, chroma, or the like of the object to be measured. In the ranging device described in Japanese Laid-Open Patent Publication (Kokai) No. 2002-207163, image capturing is performed regardless of whether or not the ranging state is good and whether or not the focusing state is good. Therefore, there is a problem that even in a case where the ranging state is not good or the focusing state is not good, a captured image in the state remaining not good is recorded.

### SUMMARY OF THE INVENTION

The present invention provides a ranging device that makes it possible to record image data in a state preferable to a photographer, a method of controlling the ranging device, and a storage medium.

In a first aspect of the present invention, there is provided a ranging device that is communicably connected to an image capturing unit that captures an image of an object, a focus adjustment unit that performs focus adjustment with respect to the object for the image capturing unit, and a recording unit that is capable of executing record processing for recording image data of the object subjected to image capturing by the image capturing unit, including at least one processor, and a memory coupled to the at least one processor storing instructions that, when executed by the processor, cause the processor to function as: a ranging unit configured to measure a distance to the object, a determination unit configured to determine, based on a result of focus adjustment performed by the focus adjustment unit, whether or not the object is in an in-focus state, and a control unit configured to be capable of performing control to restrict execution of the record processing in a case where, even when the distance has been measured by the ranging unit, it is determined by the determination unit that the object is not in the in-focus state.

In a second aspect of the present invention, there is provided a method of controlling a ranging device that is communicably connected to an image capturing unit that captures an image of an object, a focus adjustment unit that performs focus adjustment with respect to the object for the image capturing unit, and a recording unit that is capable of executing record processing for recording image data of the object subjected to image capturing by the image capturing unit, including measuring a distance to the object, determining, based on a result of focus adjustment performed by the focus adjustment unit, whether or not the object is in an in-focus state, and enabling performing control to restrict execution of the record processing in a case where, even when the distance has been measured by the ranging, it is determined by the determining that the object is not in the in-focus state.

According to the present invention, it is possible to record image data in a state preferable to a photographer.

Further features of the present invention will become apparent from the following description of exemplary embodiments (with reference to the attached drawings).

### BRIEF DESCRIPTION OF THE DRAWINGS

FIG. 1 is a perspective view showing an example of the appearance of an image capturing apparatus to which a ranging device is applied.

FIG. 2 is a block diagram showing an example of a hardware configuration of the image capturing apparatus shown in FIG. 1.

FIGS. 3A and 3B are diagrams each showing an example of an image displayed after ranging is performed in a ranging mode or a simultaneous recording mode.

FIG. 4 is a flowchart of a process performed by the image capturing apparatus in the simultaneous recording mode.

FIG. 5 is a flowchart of a process performed by the image capturing apparatus according to a second embodiment in the simultaneous recording mode.

### DESCRIPTION OF THE EMBODIMENTS

The present invention will now be described in detail below with reference to the accompanying drawings showing embodiments thereof. The following description of the configurations of the embodiments is given by way of example, and the scope of the present invention is not limited to the described configurations of the embodiments. For example, components of the configuration can be replaced by desired ones which can exhibit the same function. Further, desired components can be added. Further, two or more desired components (features) of the embodiments can be combined.

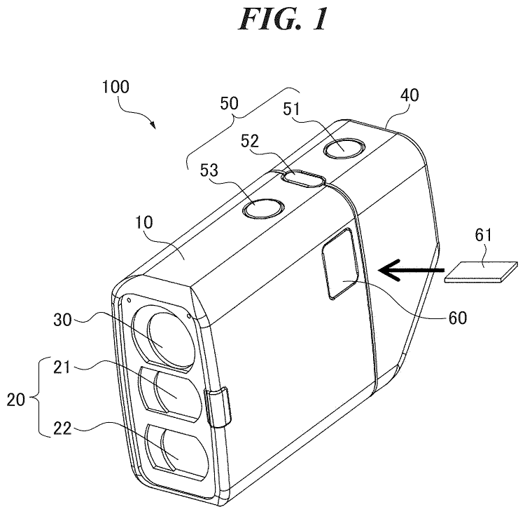

A first embodiment will be described below with reference to FIGS. 1 to 4. FIG. 1 is a perspective view showing an example of the appearance of an image capturing apparatus to which a ranging device is applied. The image capturing apparatus shown in FIG. 1, denoted by reference numeral 100, includes an apparatus body 10, an eyepiece section 40 into which a user (photographer) looks when image capturing is performed, and an operation section (operation unit) 50 arranged over the apparatus body 10 and the eyepiece section 40. The apparatus body 10 includes a ranging section (ranging unit) 20, an image capturing section (image capturing unit) 30, and a recording medium interface (I/F) 60. The ranging section 20 includes a light emission section 21 and a light receiving section 22. The light emission section 21 irradiates an object with a laser beam. The light receiving section 22 receives a reflected light of the laser beam emitted from the light emission section 21 and reflected from the object. With this, the ranging section 20 can measure a distance from the image capturing apparatus 100 to the object based on a time difference from irradiation of the laser beam from the light emission section 21 to detection of the reflected light by the light receiving section 22, i.e. the flight time of light. Thus, in the present embodiment, the ranging section 20 is configured to be capable of measuring a distance by using the TOF method. With this, it is possible to accurately measure a distance from the image capturing apparatus 100 to an object with the simple configuration. The image capturing section 30 generates image data expressing an image of an object included in an image capturing range of a predetermined angle of view. With this, it is possible to capture an image of the object. Note that the light emission section 21 is adjusted such that it is enabled to irradiate laser beam in a predetermined direction within the image capturing range of the image capturing section 30. In the recording medium I/F 60, a recording medium 61 is removably attached. The recording medium 61 is recording means capable of executing record processing for recording image data of an object which is subjected to image capturing by the image capturing section 30. The recording medium 61 accommodated in the recording medium I/F 60 can communicate with the image capturing apparatus 100 via the recording medium I/F 60. The recording medium 61 is not particularly limited, but for example, a memory card, such as an SD card, can be used. Note that the recording medium 61 is not limited to the removable one but can be fixedly incorporated in the apparatus body 10. In this case, the recording medium I/F 60 can be omitted.

The eyepiece section 40 has a display device (not shown), such as a transmissive liquid crystal panel, arranged therein. On the display device, a live view image based on image data sequentially acquired from the image capturing section 30 is displayed. This enables the display device to function as an electronic viewfinder (EVF). Note that it is possible to superimpose and display an image indicating a result of ranging performed by the ranging section 20, information on the image capturing apparatus 100, and so forth, on the live view image. Further, on the display device, it is possible to display image data read from the recording medium 61. Further, the user can operate an operation button 51 of the operation section 50 while visually recognizing an image displayed on the display device within the eyepiece section 40. This enables the user to instruct execution of ranging and image capturing and the like.

The operation section 50 includes the operation button 51, an operation button 52, and an operation button 53. Input devices have names corresponding to functions assigned to the input devices, respectively. Referring to FIG. 1, the operation button 51 is a button operated when instructing execution of ranging and image capturing, and the like, as mentioned above. The operation button 52 is a power button for switching on/off of the power of the image capturing apparatus 100. The operation button 53 is a switching button for switching a variety of operation modes, such as an image capturing mode. Note that the operation section 50 is not limited to the configuration including the operation buttons 51 to 53. Further, the operation section 50 is not limited to a configuration formed by buttons, but for example, the operation section 50 can be an input device which can be operated by a user, such as a touch panel, a dial, a direction key (cross key), and a joystick.

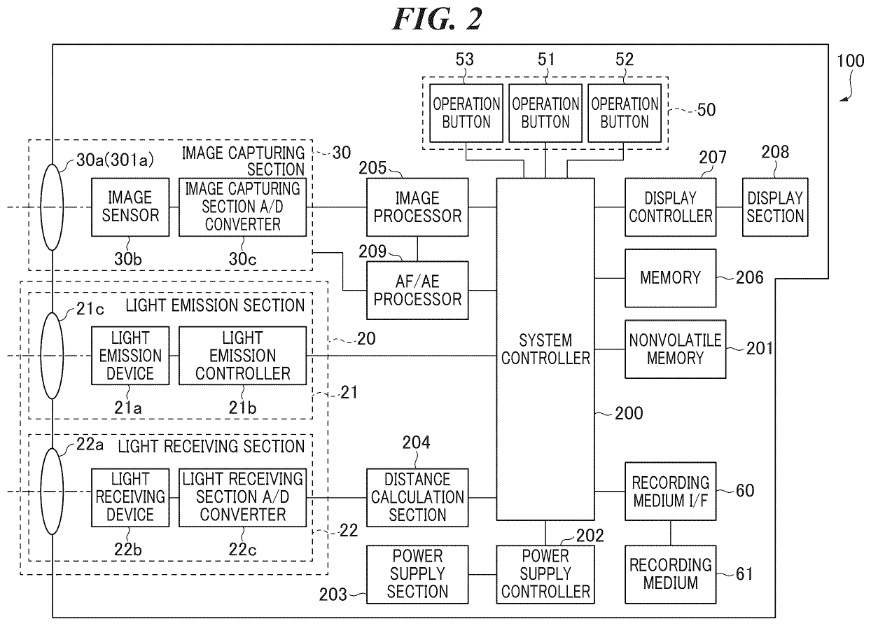

FIG. 2 is a block diagram showing an example of a hardware configuration of the image capturing apparatus shown in FIG. 1. As shown in FIG. 2, the image capturing apparatus 100 includes a system controller (control unit) 200, a nonvolatile memory (recording medium) 201, a power supply controller 202, and a power supply section 203. Further, the image capturing apparatus 100 includes a distance calculation section 204, an image processor 205, a memory 206, a display controller 207, a display section 208, and an automatic focus detection (AF)/automatic exposure control (AE) processor 209. The hardware items included in the image capturing apparatus 100 are communicably connected to each other. The system controller 200 includes one or more processors, such as a central processing unit (CPU), a micro processing unit (MPU), and a microprocessor. The system controller 200 controls the operations of the components of the image capturing apparatus 100 and realizes the functions of the image capturing apparatus 100 by loading associated programs stored in the nonvolatile memory 201 into the memory 206 and executing the loaded programs. The nonvolatile memory 201 can be electrically erasable and recordable. The nonvolatile memory 201 stores the programs executed by the system controller 200, a variety of setting values of the image capturing apparatus 100, and graphical user interface (GUI) data, such as a menu screen and an image superimposed on the live view image. These programs include, for example, a program for causing a computer (e.g. the CPU) to execute a method of controlling the components and means of the image capturing apparatus 100 (method of controlling the ranging device).

The memory 206 is temporary recording means for executing read processing for reading a program executed by the system controller 200 and executing temporary record processing for temporarily storing (recording) a result of ranging performed by the ranging section 20, image data obtained by the image capturing section 30, and so forth. Further, part of the memory 206 is used as a video memory for storing image data for display. By storing an image generated by combining the live view image and an image expressing additional information, such as a ranging result, in the video memory, it is possible to display the image expressing the additional information in a state superimposed on the live view image. The image display on the display section 208 is controlled by the display controller 207. Specifically, the display controller 207 generates display signals in a format appropriate to the display section 208 based on the image data stored in the video memory area of the memory 206 and outputs the generated display signals to the display section 208. The display section 208 is a display device, such as a liquid crystal display device, arranged within the eyepiece section 40. The power supply controller 202 detects a type of a power supply (a battery or an external power supply) as the power supply section 203, and a type, a remaining amount, and so forth of a battery connected to the power supply section 203. Further, the power supply controller 202 supplies electric power necessary for the blocks including the recording medium 61, based on a result of detection concerning the power supply section 203 and the control of the system controller 200. The power supply section 203 is a battery or an external power supply (such as an AC adapter).

The light emission section 21, the light receiving section 22, and the distance calculation section 204 form the ranging section 20 that measures a distance to a predetermined position within the image capturing range of the image capturing section 30. The light emission section 21 includes a light emission device 21a, a light emission controller 21b, and an irradiation lens 21c. The light emission device 21a is e.g. a semiconductor laser element (laser diode) and is configured to output invisible near infrared light in the present embodiment. The light emission controller 21b controls the operation of the light emission device 21a such that the light emission device 21a is capable of outputting a pulsed laser beam based on a control signal output from the system controller 200. The laser beam output from the light emission device 21a is condensed by the irradiation lens 21c and is output from the image capturing apparatus 100. The light receiving section 22 includes a light receiving lens 22a, a light receiving device 22b, and a light receiving section analogue-to-digital (A/D) converter 22c. The light receiving section 22 detects reflected light of the laser beam output from the light emission section 21. The light receiving lens 22a condenses incident light on a light receiving surface of the light receiving device 22b. The light receiving device 22b is e.g. a photo diode. The light receiving device 22b outputs a light reception signal (analog signal) having a magnitude corresponding to an amount of incident light by photoelectric conversion. The light reception signal (analog signal) output from the light receiving device 22b is converted to a digital signal by the light receiving section A/D converter 22c. The light receiving section A/D converter 22c outputs the digital signal to the distance calculation section 204. Note that in a case where the light receiving device 22b is an avalanche photo diode (APD), a value (digital value) corresponding to the amount of received light can be obtained by counting the number of pulses output from the APD, and hence it is possible to omit the light receiving section A/D converter 22c. The distance calculation section 204 can measure a distance to an object which reflects the laser beam, based on a time period (TOF) from a time of outputting the laser beam from the light emission device 21a to a time of detecting the reflected light by the light receiving device 22b. Note that reflected light of a laser beam cannot be always detected by the light receiving section 22, depending on a distance to an object existing in an advancing direction of the laser beam, a state of a surface of the object, and the like. For example, in a case where the reflected light cannot be properly detected by the light receiving section 22, such as a case where the reflected light is not detected by the light receiving section 22 within a predetermined time period and a case where the intensity of the detected reflected light is weak, it can be difficult for the distance calculation section 204 to measure a distance to the object. In a case where the distance has been successfully measured, the distance calculation section 204 outputs the measured distance to the system controller 200 as a result of ranging. On the other hand, in a case where measurement of the distance is unsuccessful, the distance calculation section 204 outputs information indicating this failure in measurement of the distance to the system controller 200 as a result of ranging. Note that in a case where a distance which cannot be normally obtained is measured, e.g. as a distance of 0, the distance calculation section 204 can output information indicating a failure in the measurement.

The image capturing section 30 includes an imaging optical system 30a, an image sensor 30b, and an image capturing section A/D converter 30c. The imaging optical system 30a has a plurality of lenses. The plurality of lenses include a focus lens 301a for adjusting a focusing distance of the imaging optical system 30a. The system controller 200 performs automatic focusing control (focus adjustment) and automatic exposure control (exposure adjustment) using the AF/AE processor 209. In the present embodiment, the focus lens 301a and the AF/AE processor 209 function as a focus adjustment unit configured to perform focus adjustment on an object in the image capturing section 30. Further, the AF/AE processor 209 also functions as an exposure adjustment unit configured to perform exposure adjustment in the image capturing section 30. Further, in a case where the focal length of the imaging optical system 20a is variable, a zoom lens is included in the plurality of lenses. Further, in a case where the image capturing apparatus 100 has a lens-shift type image blur correction function, a shift lens is included in the plurality of lenses. The image sensor 30b is e.g. a charge coupled device (CCD) or complementary metal-oxide-semiconductor (CMOS) color image sensor having color filters of the primary color Bayer array. The image sensor 30b has a pixel array in which a plurality of pixels are two-dimensionally arranged and a peripheral circuit for reading a signal from each pixel. Each pixel accumulates electrical charge corresponding to an amount of incident light, which is obtained by photoelectric conversion. Signals each having a voltage corresponding to an amount of electrical charge accumulated during an exposure period are read from the pixels, respectively, whereby a pixel signal group (analog image signals) expressing an object image formed on an imaging surface by the imaging optical system 30a can be obtained. The operations of the image capturing section 30, such as image capturing and the focusing distance adjustment, are controlled by the system controller 200. The image capturing section A/D converter 30c converts analog image signals output from the image sensor 30b to digital signals (image data) by A/D conversion. The image data output from the image capturing section A/D converter 30c is output to the image processor 205.

The image processor 205 applies predetermined image processing to the image data output from the image capturing section A/D converter 30c to generate signals and image data according to the purpose of use, and acquire and generate a variety of information. The image processor 205 can be a dedicated hardware circuit, such as an application specific integrated circuit (ASIC), which is designed to realize a specific function. Further, the image processor 205 can be configured such that a specific function is realized by a processor, such as a digital signal processor (DS) or a graphics processing unit (GPU), executing software. The image processor 205 outputs information and data to the system controller 200.

Examples of the image processing applied to image data by the image processor 205 include pre-processing, color interpolation processing, correction processing, detection processing, data processing, evaluation value calculation processing, and special effect processing. The image processing is not limited to these examples. The pre-processing includes signal amplification, reference level adjustment, defective pixel correction, and so forth. The color interpolation processing is processing performed in a case where the color filters are provided in the image sensor 30b, for interpolating values of color components not included in individual pixel data forming image data. The color interpolation processing is also referred to as demosaic processing. The correction processing includes processing operations, such as white balance adjustment, gradation correction, correction (image restoration) of an image deteriorated due to optical aberration of the imaging optical system 30a, correction of an influence of light reduction around the imaging optical system 30a, and color correction. The detection processing includes detection of a feature area (such as a face area and a human body area) and movement of the feature area, person recognition processing, and so forth. The data processing includes processing operations, such as cutting out of an area (trimming), combining, scaling, encoding and decoding, and generation of header information (data file generation). Further, the data processing also includes generation of image data for display and image data for recording. The evaluation value calculation processing includes processing operations, such as generation of signals and evaluation values, used for AF, and generation of evaluation values used for AE. In a case where a signal and an evaluation value, used for AF, are generated, the AF/AE processor 209 drives the focus lens 301a based on the generated signals and evaluation values. With this, focus adjustment is performed and AF processing is performed. In a case where evaluation values used for AE are generated, the AF/AE processor 209 adjusts the sensitivity based on the evaluation values. With this, AE processing is performed. Note that the AE processing can be performed by changing an aperture or a shutter speed. Further, in a case where the contrast of the object is relatively low, the object is relatively dark, or further, the object is too closer than a shortest image capturing distance of the lens, the AF processing can fail. Further, also in the AE processing, in a case where the object is relatively too bright, or the brightness varies, the AE processing can fail. The special effect processing includes processing operations, such as addition of a blur effect, change of a color tone, and relighting. The system controller 200 stores image data output from the image processor 205 in the memory 206. The system controller 200 stores image data for display in the video memory area of the memory 206. Further, the system controller 200 generates image data representing information on e.g. a ranging result obtained from the distance calculation section 204 and stores the generated image data in the video memory area of the memory 206. This image data is displayed in a state superimposed on the live view image.

The system controller 200 monitors operations of the operation buttons 51 to 53 of the operation section 50. The system controller 200 executes a predetermined operation according to an operation performed on the operation buttons 51 to 53. In a case where an operation of the operation button 51 is detected, the system controller 200 executes recording of an image captured by the image capturing section 30, measurement of a distance by the ranging section 20, and so forth. In a case where an operation of the operation button 52 is detected, the system controller 200 switches power-on and power-off of the image capturing apparatus 100.

In a case where an operation of the operation button 53 is detected, the system controller 200 switches the operation mode of the image capturing apparatus 100. The image capturing apparatus 100 has the image capturing mode, a ranging mode, and a simultaneous recording mode, as the operation modes. The image capturing mode is a mode in which the operation of the operation button 51 is regarded as an instruction for starting or terminating recording. In a case where the image capturing apparatus 100 shifts to the power-on state, the system controller 200 executes an operation in a standby state. The operation in the standby state is an operation for causing the display section 208 to function as the electronic viewfinder. Specifically, the system controller 200 causes the image processor 205 to generate image data for display based on image data sequentially acquired from the image capturing section 30. Further, the system controller 200 causes the display controller 207 to perform display on the display section 208. The system controller 200 in the image capturing mode waits for an operation of the operation button 51 while continuing the live view display on the display section 208. Then, in a case where an operation of the operation button 51 is detected, the system controller 200 records e.g. one frame of the image data for display in the recording medium 61 as a still image. Alternatively, the system controller 200 starts to record the live view image in the recording medium 61 as a moving image. Whether to record a still image or a moving image can be changed by a setting set in advance. In a case where recording of a still image is set, the system controller 200 records a still image whenever an operation of the operation button 51 is detected. On the other hand, in a case where recording of a moving image is set, the system controller 200 repeats the start and stop of recording of a moving image whenever an operation of the operation button 51 is detected. In the image capturing mode, execution of measurement of a distance is stopped.

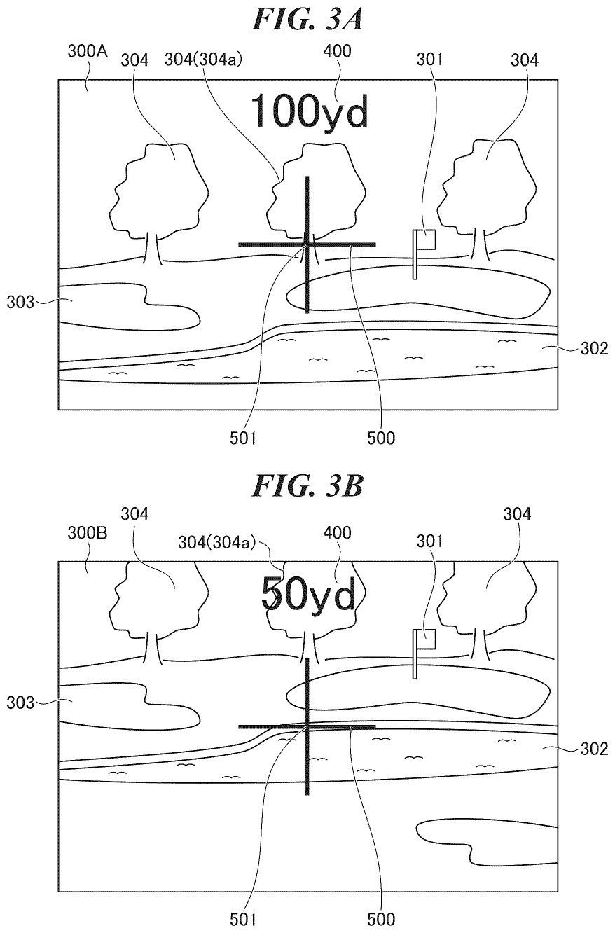

The system controller 200 in the ranging mode waits for an operation of the operation button 51 while continuing the live view display on the display section 208. Note that on the live view image in the ranging mode, an image of an index 500 (see FIGS. 3A and 3B), such as a cursor or a pointer, which indicates a ranging point (ranging target) is superimposed for display at a predetermined position. In a case where an operation of the operation button 51 is detected, the system controller 200 executes a ranging operation. The system controller 200 controls the light emission controller 21b to output a pulsed laser beam from the light emission device 21a and enables (activates) the light receiving section 22 and the distance calculation section 204. After that, in a case where a ranging result is received from the distance calculation section 204, the system controller 200 displays the received ranging result (a distance or a ranging failure) in a state superimposed on the live view image being displayed. Then, after a predetermined time period elapses, or in a case where an operation of the operation button 51 is detected, the system controller 200 restarts the live view display and waits for an operation of the operation button 51. Note that in a case where an operation of the operation button 51 is detected, the system controller 200 can stop update of the live view display until a predetermined time period elapses and display the ranging result in a state superimposed on a frame image displayed when the operation button 51 is operated.

The system controller 200 in the simultaneous recording mode waits for an operation of the operation button 51 while continuing the live view display on the display section 208. Note that similar to the ranging mode, the system controller 200 also displays the image of the index 500 indicating a ranging point, such as a cursor or a pointer, at a predetermined position on the live view image, in a superimposed state, in the simultaneous recording mode as well. In a case where an operation of the operation button 51 is detected, similar to the ranging mode, the system controller 200 executes a ranging operation. Further, the system controller 200 executes an operation of recording a still image or a moving image. For example, in a case where an operation of the operation button 51 is detected, the system controller 200 causes the image processor 205 to start generation of moving image data for recording. Alternatively, in a case where an operation of the operation button 51 is detected, the system controller 200 causes the image sensor 30b to execute image capturing of a still image and causes the image processor 205 to generate still image data for recording. In doing this, the system controller 200 controls the image processor 205 and a focus lens driving section (not shown) that drives the focus lens 301a to perform the AF processing and the AE processing. With these processing operations, it is possible to attempt to generate moving image data or still image data for recording, of which the focus and the brightness are adjusted. The system controller 200 stores the moving image data or still image data for recording, which has been generated by the image processor 205, in the memory 206. Note that although in the present embodiment, it is assumed that the moving image data and the still image data for recording are newly generated, this is not limitative, but for example, after recording a moving image for the live view display, one frame of the moving image for the live view display can be recorded as a still image.

The system controller 200 sequentially switches the operation mode whenever the operation button 53 is operated. Alternatively, in a case where the operation button 53 is operated, the system controller 200 can display a list screen of the operation modes and switch the operation mode to an operation mode selected by a user from this list screen. The method of selecting the operation mode is not particularly limited, but for example, a method of operating a direction key included in the operation section 50 can be used. Note that the system controller 200 can display characters, an icon, or the like indicating the current operation mode in a state superimposed on the live view image or change a light emission color of e.g. an LED provided in the image capturing apparatus 100 to a color suited to the current operation mode.

The operation section 50 sometimes has not only the operation buttons 51 to 53, but also a menu button and a direction key. In this case, the system controller 200 executes a predetermined operation according to an operation of the menu button or the direction key. For example, in a case where an operation of the menu button is detected, the system controller 200 displays a GUI of a menu screen on the display section 208. In a case where an operation of the direction key is detected in a state in which the menu screen is being displayed, the system controller 200 can change an item to be selected within the menu screen according to a direction of operating the direction key. Further, in a case where an operation of the direction key is detected in a state in which the menu screen is being displayed, the system controller 200 can change the setting according to an item in the selected state or shift the screen to another menu screen.

In a case where a ranging result is received from the distance calculation section 204, the system controller 200 displays the received ranging result in a state superimposed on the live view image. In a case where the ranging is successful, the ranging result displayed in the state superimposed on the live view image is a distance, but in a case where the ranging is unsuccessful, the same is a notification of this fact. Further, in a case where the ranging is successful, and the AF processing and the AE processing are successful, the system controller 200 records the moving image data for recording or the still image data for recording, which is stored in the memory 206, in the recording medium 61 in a state associated with the ranging result. Here, the “the ranging is successful” means that a result of ranging to an object, i.e. a distance has been obtained. The “the ranging is unsuccessful” means that a result of ranging to an object (distance) has not been obtained. Further, the “the AF processing is successful” means that an object is brought into focus, i.e. an object is in the in-focus state. The “the AF processing is unsuccessful” means that an object is not brought into focus, i.e. an object is in the out-of-focus state. Further, the “the AE processing is successful” means that a proper exposure to an object has been obtained. The “the AE processing is unsuccessful” means that a proper exposure to an object has not been obtained. Note that although, in the present embodiment, the determination on whether or not the focusing in the AF processing is successful is performed by the system controller 200, this is not limitative, but for example, this determination can be performed by in-focus state-determining means provided separately from the system controller 200. Similarly, although the determination on whether or not the exposure in the AE processing is successful (exposure properness determination) is performed by the system controller 200 in the present embodiment, this determination can be performed, for example, by exposure determining means provided separately from the system controller 200. In a case where information indicating that the ranging is unsuccessful is received, or information indicating that the AF processing or the AE processing is unsuccessful is received, the system controller 200 discards the image data stored in the memory 206 without recording the image data in the recording medium 61.

Note that in the moving image data and the still image data, information concerning image capturing date and time and settings at the time of image capturing, and the like are recorded e.g. at a file header of each image data. Similar to the moving image data and the still image data, the ranging result can be recorded at the file header or can be recorded in a file different from the file header. In a case where the ranging result is recorded in a different file, it is preferable to record the ranging result with a file name including e.g. a common character string so as to make a user recognize that the image data file and the distance information file are associated with each other.

FIGS. 3A and 3B are diagrams each showing an example of an image displayed after performing ranging in the ranging mode or the simultaneous recording mode. A captured image 300A shown in FIG. 3A and a captured image 300B shown in FIG. 3B are each an image of a golf course, which is captured by the image capturing apparatus 100. Further, in the captured image 300A and the captured image 300B, a flag 301, a pond 302, a bunker 303, three trees 304, and so forth are included, respectively. The captured image 300A is an image in a case where a distance to a tree 304a positioned in the center of the three trees 304 is measured. The captured image 300B is an image in a case where a distance to an edge on a far side of the pond 302 is measured. As mentioned above, in the ranging mode, the index 500 indicating the ranging position is displayed in a state superimposed on the live view image. As the index 500, a cross-shaped cursor (image) is used in a configuration of display in FIGS. 3A and 3B, but this is not limitative, and for example, a dot image, an image of an arrow shape, or the like can be used. In a case where the index 500 is a cross-shaped cursor, an intersection 501 of the cross shape is superimposed on a captured image 300 (300A, 300B) at a predetermined position (e.g. the center of the captured image 300).

The ranging section 20 is adjusted so as to output a laser beam from the light emission section 21 toward a position corresponding to the intersection 501 of the index 500 within the image capturing range of the image capturing section 30. With this, the user can measure a distance to a ranging target using the ranging section 20 by operating the operation button 51 in a state in which the intersection 501 of the index 500 is adjusted to a position desired to measure a distance, i.e. in a state in which the direction of the image capturing apparatus 100 is adjusted to the ranging target. Then, in a case where the measurement of the distance has been normally performed and the ranging is successful, an image 400 indicating the distance is displayed as the ranging result in a state superimposed on the live view image. In the captured image 300A, the tree 304a is the ranging target, and a distance of “100 yd” to the tree 304a is displayed as the image 400 in a superimposed state. In the captured image 300B, the pond 302 is the ranging target, and a distance of “50 yd” to the edge on the far side of the pond 302 is displayed as the image 400 in a superimposed state. Although the unit of the distance to the ranging target is “yd” in the configuration of display in FIGS. 3A and 3B, this is not limitative, but for example, “m” can be used. Note that in a case where the ranging is unsuccessful, the image 400 including a character string (message) or a mark indicating this fact, such as “Error”, “x”, or “ranging is unsuccessful”, is displayed in a superimposed state. Thus, the image 400 functions as a notification unit configured to notify a user of a result of ranging performed by the ranging section 20. With this, the user can grasp, in a case where the ranging is successful, a distance to the ranging target and can grasp, in a case where the ranging is unsuccessful, this fact.

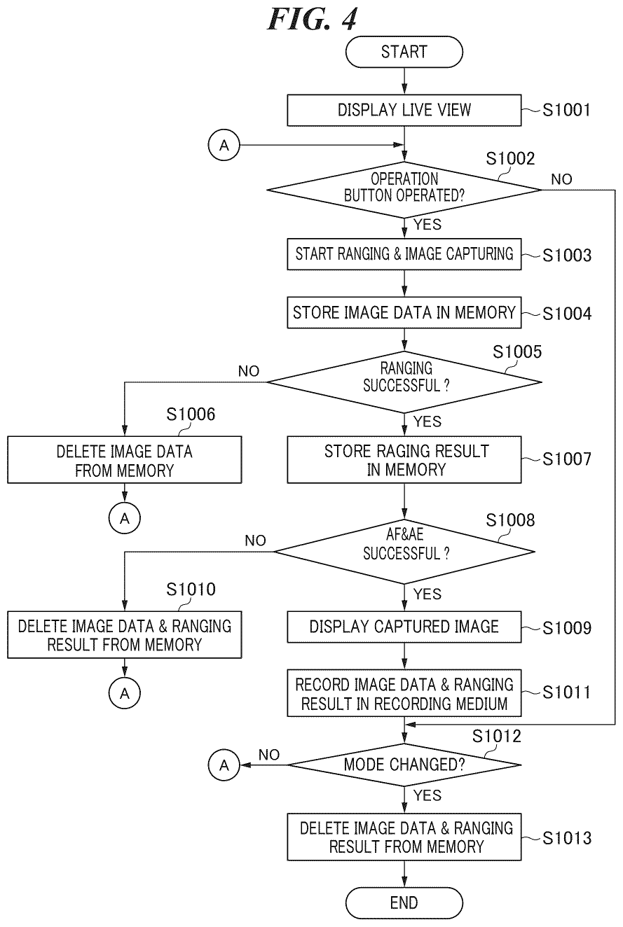

FIG. 4 is a flowchart of a process performed by the image capturing apparatus in the simultaneous recording mode. The process in FIG. 4 is realized by the system controller 200 that executes a program stored in the nonvolatile memory 201 to control the operations of the components. Further, the process in FIG. 4 is started when the simultaneous recording mode is selected by the operation button 53 in the power-on state of the image capturing apparatus 100. As shown in FIG. 4, in a step S1001, the system controller 200 causes associated components to execute operations necessary for the live view display so as to cause the display section 208 to function as the electronic viewfinder. The system controller 200 causes the image processor 205 to generate image data for display based on image data sequentially acquired from the image capturing section 30. The system controller 200 stores one frame of the image data for display in the video memory area of the memory 206 and combines the image of the index 500 (see FIGS. 3A and 3B) indicating the ranging position with the image data in the video memory. Note that the system controller 200 can also similarly combine an image indicating other information, such as an image indicating a battery remaining amount or the operation mode, with the image data. Further, the system controller 200 controls the display controller 207 to display the combined image data stored in the video memory area of the memory 206 on the display section 208. The system controller 200 realizes the live view display on the display section 208 by repeatedly executing these operations for each frame.

In a step S1002, the system controller 200 determines whether or not the operation button 51 has been operated. If it is determined in the step S1002 that the operation button 51 has been operated, the process proceeds to a step S1003. On the other hand, if it is determined in the step S1002 that the operation button 51 has not been operated, the process proceeds to a step S1012.

In the step S1003, the system controller 200 controls the light emission controller 21b to output a pulsed laser beam from the light emission device 21a and enables (activates) the light receiving section 22 and the distance calculation section 204. With this, ranging is performed. Further, the system controller 200 controls the image capturing section 30 to execute capturing of a still image or moving image for recording, and controls the image processor 205 to generate image data for recording. With this, image capturing is performed. This image data is image data which can be an object to be recorded in the recording medium 61 in a step S1011, referred to hereinafter.

In a step S1004, the system controller 200 stores the image data for recording, which has been generated by the image processor 205 in the step S1003, in the memory 206.

In a step S1005, the system controller 200 determines, based on a ranging result acquired from the distance calculation section 204, whether or not measurement of the distance is successful. If it is determined in the step S1005 that measurement of the distance is successful, the process proceeds to a step S1007. On the other hand, if it is determined in the step S1005 that measurement of the distance has is not successful, i.e. has failed, the process proceeds to a step S1006.

In the step S1006, the system controller 200 deletes the image data for recording, which has been temporarily stored in the memory 206 in the step S1004. After execution of the step S1006, the process returns to the step S1002, and the step S1002 et seq. are sequentially executed.

In the step S1007, the system controller 200 temporarily stores the ranging result obtained in the step S1003, i.e. the distance data (information on the distance) in the memory 206.

In a step S1008, the system controller 200 determines, based on a result of the AF processing (focus adjustment result) and a result of the AE processing (exposure adjustment result), which have been acquired from the image processor 205 in the step S1003, whether or not the AF processing and the AE processing are successful. Thus, the system controller 200 also functions as a determination unit configured to determine whether or not the AF processing and the AE processing are successful. Then, if it is determined in the step S1008 that the AF processing and the AE processing are successful, the process proceeds to a step S1009. On the other hand, if it is determined in the step S1008 that the AF processing and the AE processing are not successful, the process proceeds to a step S1010.

In the step S1010, the system controller 200 deletes the image data for recording, which has been temporarily stored in the memory 206 in the step S1004, and the ranging result temporarily stored in the memory 206 in the step S1007. After execution of the step S1010, the process returns to the step S1002, and the step S1002 et seq. are sequentially executed.

In the step S1009 after execution of the step S1008, the system controller 200 combines the ranging result temporarily stored in the memory 206 in the step S1007 with the frame image stored in the video memory area of the memory 206 in the step S1001. With this, the captured image 300A (see FIG. 3A) or the captured image 300B (see FIG. 3B), on which e.g. the index 500 and the image 400 indicating the distance are superimposed, is displayed on the display section 208. Note that in the above description, to simplify the processing, the system controller 200 combines the image indicating the distance with the live view image at a time when the operation button 51 is operated and displays the combined image, but this is not limitative. For example, the system controller 200 can generate combined image data by combining the index 500 and the image 400 with the image data for recording, which has been stored in the memory 206, and display this combined image data on the display section 208 after scaling.

In the step S1011, the system controller 200 records the image data for recording, which has been stored in the memory 206 in the step S1004, and the ranging result stored in the memory 206 in the step S1007, in the recording medium 61 in an associated state. Note that the ranging result can be recorded as an image indicating the distance after being combined with the image data for recording, and can be recorded as a value indicating the distance in a state included in metadata of a data file for storing the image data for recording. Further, the ranging result can be recorded in the image data for recording and the metadata of the data file, respectively. Note that in a case where the ranging result is recorded as an image, it is preferable to also combine the index 500 indicating the ranging position with the image data for recording. Further, in a case where a moving image is recorded, it is preferable to combine the ranging result and the index 500 (cursor) with each frame. Further, the ranging position (coordinates) in the image can be recorded as metadata, but for example, in a case where the image data is reproduced by the image capturing apparatus 100, the ranging position in the image is known (the center of the image), and hence the ranging position can be omitted. Further, in a case where the ranging result is recorded only as a numerical value (distance data), when reproducing and displaying the image data for recording, the system controller 200 can acquire the distance data from the metadata, convert the distance data to the image 400, and display the image 400 together with the index 500 in a state combined with the image data.

In the step S1012, the system controller 200 determines whether or not the operation mode has been changed. If it is determined in the step S1012 that the operation mode has been changed, the process proceeds to a step S1013. On the other hand, if it is determined in the step S1012 that the operation mode has not been changed, the process returns to the step S1002, and the step S1002 et seq. are sequentially executed. Note that the determination on a change of the operation mode is performed based on the operation of the operation button 53, but beside this, the determination is also performed based on a state in which the power is turned off by operating the operation button 52.

In the step S1013, the system controller 200 deletes the image data for recording and the ranging result, which remain in the memory 206, followed by terminating the present process. Note that in the process in FIG. 4, the step S1005 and the step S1008 can be reversed in the order of execution. Further, in the process in FIG. 4, the step S1009 and the step S1011 can be reversed in the order of execution, or the step S1009 and the step S1011 can be executed in parallel.

As described above, in the present embodiment, there is a case where even when the distance has been measured by the ranging section 20 in the step S1003, it is determined in the step S1008 that the AF processing is unsuccessful (out-of-focus state), and the AE processing is also unsuccessful (improper exposure adjustment). In this case, in the step S1010, as the control to restrict execution of final recording (record processing) in the recording medium 61, the system controller 200 deletes the image data for recording and the ranging result, which have been temporarily stored in the memory 206. On the other hand, there is also a case where the distance has been measured by the ranging section 20 in the step S1003, and it is determined in the step S1008 that the AF processing is successful (in-focus state), and the AE processing is also successful (proper exposure adjustment). In this case, the system controller 200 executes final recording in the recording medium 61 in the step S1011. With this control, it is possible to prevent the capacity of the recording medium 61 from being wastefully consumed by recording image data in a case where e.g. the AF processing and the AE processing are unsuccessful, and prevent an unnecessary image from being displayed when the image data recorded in the recording medium 61 is reproduced. Further, it is possible to quickly and easily retrieve image data for which the ranging has been successfully performed and the focus and the brightness have been adjusted, from image data recorded in the recording medium 61. Thus, in the image capturing apparatus 100, it is possible to record image data in a state preferable to a user (photographer). Further, in the image capturing apparatus 100, in a case where a distance has not been measured by the ranging section 20 (NO in the step S1005), the determination of whether or not the AF processing and the AE processing have been successfully performed (step S1008) is omitted. The image data on which the ranging is unsuccessful is unnecessary data for a user, and it is possible to prevent the data from being recorded in the recording medium 61.

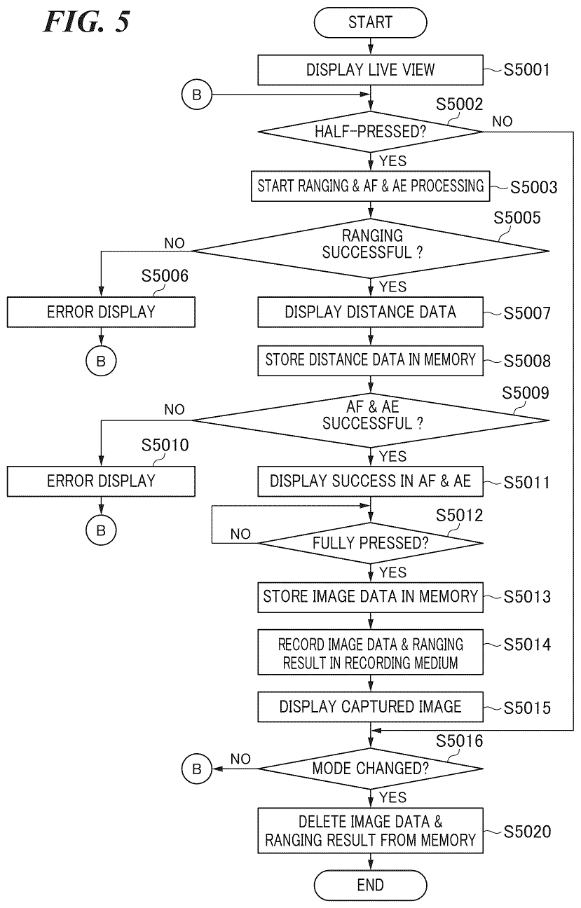

A second embodiment will be described below with reference to FIG. 5, but the description will be given mainly of a different point from the above-described first embodiment, and description of the same points is omitted. The present embodiment is the same as the first embodiment except that the operation button 51 has a two-stage switch structure which can be pressed in two stages. Specifically, the operation button 51 is a two-stage switch having a switch SW1 (not shown) and a switch SW2 (not shown). On the halfway of operating the operation button 51 (such as a half-pressing operation), i.e. in the first stage, the switch SW1 is turned on. At this time, start of the ranging operation, the AF processing, and the AE processing is instructed. Further, when the operation of the operation button 51 is completed (such as a fully pressing operation), i.e. in the second stage, the switch SW2 is turned on. At this time, the start of the image capturing operation and recording of captured image data is instructed.

FIG. 5 is a flowchart of a process performed by the image capturing apparatus according to the second embodiment in the simultaneous recording mode. As shown in FIG. 5, in a step S5001, the system controller 200 causes associated components to execute operations necessary for the live view display so as to cause the display section 208 to function as the electronic viewfinder. The system controller 200 causes the image processor 205 to generate image data for display, based on image data sequentially acquired from the image capturing section 30. The system controller 200 stores one frame of the image data for display in the video memory area of the memory 206 and combines the image of the index 500 (see FIGS. 3A and 3B) indicating the ranging position with the image data in the video memory. Further, the system controller 200 controls the display controller 207 to display the combined image data stored in the video memory area of the memory 206 on the display section 208. The system controller 200 realizes the live view display on the display section 208 by repeatedly executing these operations for each frame.

In a step S5002, the system controller 200 determines whether or not the operation button 51 has been half-pressed, i.e. the switch SW1 has been turned on. If it is determined in the step S5002 that the operation button 51 has been half-pressed, the process proceeds to a step S5003. On the other hand, if it is determined in the step S5002 that the operation button 51 has not been half-pressed, the process proceeds to a step S5016.

In the step S5003, the system controller 200 controls the light emission controller 21b to output a pulsed laser beam from the light emission device 21a and enables (activates) the light receiving section 22 and the distance calculation section 204. With this, ranging is performed. Further, the system controller 200 controls the image processor 205, a focus lens driving section, not shown, for driving the focus lens 301a, and so forth, to start the AF processing and the AE processing.

In a step S5005, the system controller 200 determines, based on a ranging result acquired from the distance calculation section 204, whether or not measurement of the distance is successful. If it is determined in the step S5005 that measurement of the distance is successful, the process proceeds to a step S5007. On the other hand, if it is determined in the step S5005 that measurement of the distance is not successful, the process proceeds to a step S5006.

In the step S5006, the system controller 200 displays information indicating the unsuccessful distance measurement determined in the step S5005, as an error, in a state superimposed on the live view display being displayed on the display section 208. After execution of the step S5006, the process returns to the step S5002, and the step S5002 et seq. are sequentially executed.

In the step S5007 after execution of the step S5003, the system controller 200 displays the distance determined as successfully measured in the step S5005 in a state superimposed on the live view display being displayed on the display section 208.

In a step S5008, the system controller 200 temporarily stores the ranging result obtained in the step S5003, i.e. the distance data in the memory 206.

In a step S5009, the system controller 200 determines, based on a result of the AF processing and a result of the AE processing, which have been acquired from the image processor 205 in the step S5003, whether or not the AF processing and the AE processing are successful. If it is determined in the step S5009 that the AF processing and the AE processing are successful, the process proceeds to a step S5011. On the other hand, if it is determined in the step S5009 that the AF processing and the AE processing are not successful, the process proceeds to a step S5010.

In the step S5010, the system controller 200 displays information indicating unsuccessful AF processing and unsuccessful AE processing, which have been determined in the step S5008, as an error in a state superimposed on the live view display being displayed on the display section 208. After execution of the step S5010, the process returns to the step S5002, and the step S5002 et seq. are sequentially executed.

In the step S5011, the system controller 200 displays information indicating successful AF processing and successful AE processing, which have been determined in the step S5008, in a state superimposed on the live view display being displayed on the display section 208.

In a step S5012, the system controller 200 determines whether or not the operation button 51 has been fully pressed, i.e. the switch SW2 has been turned on. If it is determined in the step S5012 that the operation button 51 has been fully pressed, the process proceeds to a step S5013. On the other hand, if it is determined in the step S5012 that the operation button 51 has not been fully pressed, the process remains in the step S5012. That is, the step S5012 is repeated.

In the step S5013, the system controller 200 controls the image capturing section 30 to perform image capturing and controls the image processor 205 to generate image data for recording. Then, the system controller 200 stores the image data for recording, which has been generated by the image processor 205, in the memory 206.

In a step S5014, the system controller 200 records the image data for recording, which has been stored in the memory 206 in the step S5013, and the ranging result temporarily stored in the memory 206 in the step S5008, in the recording medium 61 in an associated state.

In a step S5015, the system controller 200 combines the ranging result stored in the memory 206 in the step S5008 with the frame image stored in the video memory area of the memory 206 in the step S5001. With this, the captured image 300A (see FIG. 3A) or the captured image 300B (see FIG. 3B), on which e.g. the index 500 and the image 400 indicating the distance are superimposed, is displayed on the display section 208.

In the step S5016, the system controller 200 determines whether or not the operation mode has been changed. If it is determined in the step S5016 that the operation mode has been changed, the process proceeds to a step S5020. On the other hand, if it is determined in the step S5016 that the operation mode has not been changed, the process returns to the step S5002, and the step S5002 et seq. are executed.

In the step S5020, the system controller 200 deletes the image data for recording and the ranging result, which remain in the memory 206, followed by terminating the present process. Note that in the process in FIG. 5, the step S5005 and the step S5009 can be reversed in the order of execution. Further, in the process in FIG. 5, the step S5014 and the step S5015 can be reversed in the order of execution or can be executed in parallel.

As described above, the image capturing apparatus 100 is configured such that the image capturing operation and recording of the captured image data are performed in a case where the operation button 51 is fully pressed after the ranging, the AF processing, and the AE processing, which are started by half-pressing the operation button 51, are successful. With this, it is possible to prevent the capacity of the recording medium 61 from being wastefully consumed by recording image data in a case where the ranging is unsuccessful, or in a case where the AF processing and the AE processing are unsuccessful. Further, it is possible to prevent an unnecessary image from being displayed when reproducing image data recorded in the recording medium 61.

The present invention has been described heretofore based on the embodiments thereof. However, the present invention is not limited to the above-described embodiments, but it can be practiced in various forms, without departing from the spirit and scope thereof. The present invention can also be accomplished by supplying a system or an apparatus with a storage medium in which a program, which realizes one or more functions of each of the above described embodiments, is stored, and causing one or more processors of a computer of the system or apparatus to read out and execute the program. Further, the present invention can also be accomplished by a circuit that realizes one or more functions (such as an ASIC). Further, although in the above-described embodiments, a case where the ranging device having the ranging function is equipped in the image capturing apparatus having the image capturing function has been described by way of example, this is not limitative. For example, the image capturing apparatus having the image capturing function and the ranging device having the ranging function are configured as separate devices, and these separated devices can be communicably connected to each other. Further, although in the above-described embodiments, the description has been given of the case where the ranging device is applied to the image capturing apparatus, this is not limitative. Examples of the apparatus to which the ranging device can be applied include not only the image capturing apparatus, but also electronic apparatuses, including a desktop-type or laptop-type personal computer, a tablet terminal (including a personal digital assistant (PDA), and a mobile phone (including a smartphone). The examples of the apparatus to which the ranging device can be applied further include a media player, a game apparatus, a robot, a drone, a drive recorder, and so forth.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-208686 filed Dec. 11, 2023, which is hereby incorporated by reference herein in its entirety.

What is claimed is:

1. A ranging device that is communicably connected to an image capturing unit that captures an image of an object, a focus adjustment unit that performs focus adjustment with respect to the object for the image capturing unit, and a recording unit that is capable of executing record processing for recording image data of the object subjected to image capturing by the image capturing unit, comprising:
at least one processor; and
a memory coupled to the at least one processor storing instructions that, when executed by the processor, cause the processor to function as:
a ranging unit configured to measure a distance to the object;
a determination unit configured to determine, based on a result of focus adjustment performed by the focus adjustment unit, whether or not the object is in an in-focus state; and
a control unit configured to be capable of performing control to restrict execution of the record processing in a case where, even when the distance has been measured by the ranging unit, it is determined by the determination unit that the object is not in the in-focus state.

2. The ranging device according to claim 1, wherein the processor is caused to further function as a temporary recording unit configured to be capable of executing temporary record processing for temporarily recording the image data which can be a target of the record processing, after ranging by the ranging unit is started until determination by the determination unit is performed.

3. The ranging device according to claim 2, wherein in a case where the distance has been measured by the ranging unit, the control unit temporarily records information concerning the distance in the temporary recording unit.

4. The ranging device according to claim 2, wherein as the control to restrict execution of the record processing, the control unit deletes the image data temporarily recorded in the temporary recording unit.

5. The ranging device according to claim 2, wherein in a case where the distance has not been measured by the ranging unit, the control unit deletes the image data temporarily recorded in the temporary recording unit.

6. The ranging device according to claim 1, wherein in a case where the distance has not been measured by the ranging unit, the determination by the determination unit is omitted.

7. The ranging device according to claim 1, wherein in a case where the distance has been measured by the ranging unit, and it is determined by the determination unit that the object is in the in-focus state, the control unit can perform control to execute the record processing.

8. The ranging device according to claim 7, wherein the control unit records the image data which can be a target of the record processing and the distance measured by the ranging unit when the image data has been acquired by the recording unit, in an associated state.

9. The ranging device according to claim 1, wherein the processor is caused to further function as an operation unit that can be pressed in two stages, and
wherein the ranging unit and the focus adjustment unit can start respective operations by a pressing operation of a first stage on the operation unit, and
wherein the image capturing unit can start the operation by a pressing operation of a second stage on the operation unit.

10. The ranging device according to claim 9, wherein in a case where the distance has been measured by the ranging unit, and it is determined by the determination unit that the object is in the in-focus state, the image capturing unit captures the image of the object when the pressing operation of the second stage is performed on the operation section.

11. The ranging device according to claim 1, wherein the ranging device is communicably connected to an exposure adjustment unit that performs exposure adjustment for the image capturing unit,
wherein the determination unit can determine whether or not exposure adjustment by the exposure adjustment unit is successful, and
wherein even when the distance has been measured by the ranging unit, in a case where it is determined by the determination unit that the exposure adjustment is unsuccessful, the control unit can perform the control to restrict execution of the record processing.

12. The ranging device according to claim 11, wherein in a case where the distance has been measured by the ranging unit, and it is determined by the determination unit that the exposure adjustment is successful, the control unit can perform control to execute the record processing.

13. The ranging device according to claim 11, further comprising an operation unit that can be pressed in two stages, and
wherein the ranging unit and the exposure adjustment unit can start respective operations by a pressing operation of a first stage on the operation unit, and
wherein the image capturing unit can start operation by a pressing operation of a second stage on the operation unit.

14. The ranging device according to claim 9, wherein in a case where the distance has been measured by the ranging unit, and it is determined by the determination unit that the exposure adjustment is successful, the image capturing unit captures the image of the object when a pressing operation of the second stage is performed on the operation unit.

15. The ranging device according to claim 1, wherein the processor is caused to further function as a notification unit configured to notify a user of a result of ranging performed by the ranging unit.

16. The ranging device according to claim 1, wherein the ranging unit is configured to be capable of measuring a distance by using the Time Of Flight (TOF) method.

17. The ranging device according to claim 1, wherein the ranging device is an image capturing apparatus comprising:
the image capturing unit;
the focus adjustment unit; and
the recording unit.

18. A method of controlling a ranging device that is communicably connected to an image capturing unit that captures an image of an object, a focus adjustment unit that performs focus adjustment with respect to the object for the image capturing unit, and a recording unit that is capable of executing record processing for recording image data of the object subjected to image capturing by the image capturing unit, comprising:
measuring a distance to the object;
determining, based on a result of focus adjustment performed by the focus adjustment unit, whether or not the object is in an in-focus state; and
enabling performing control to restrict execution of the record processing in a case where, even when the distance has been measured by the ranging, it is determined by the determining that the object is not in the in-focus state.

19. A non-transitory computer-readable storage medium storing a program for causing a computer to execute a method of controlling a ranging device that is communicably connected to an image capturing unit that captures an image of an object, a focus adjustment unit that performs focus adjustment with respect to the object for the image capturing unit, and a recording unit that is capable of executing record processing for recording image data of the object subjected to image capturing by the image capturing unit,
wherein the method comprises:
measuring a distance to the object;
determining, based on a result of focus adjustment performed by the focus adjustment unit, whether or not the object is in an in-focus state; and
enabling performing control to restrict execution of the record processing in a case where, even when the distance has been measured by the ranging, it is determined by the determining that the object is not in the in-focus state.
